(19) United States
(12) Patent Application Publication
(10) Pub. No.: US 2011/0314785 A1
(43) Pub. Date: Dec. 29, 2011

(54) Device for a cutting machine

(76) Inventor: Jonas Flädjemark, Vessigebro (SE)

(21) Appl. No.: 13/138,564

(22) PCT Filed: Mar. 1, 2010
(86) PCT No.: PCT/SE2010/000044

§ 371 Date: Sep. 6, 2011

(30) Foreign Application Priority Data
Mar. 9, 2009 (SE) 0900299-9

(51) Int. Cl. A01D 34/416

(52) U.S. Cl. 56/255

(57) ABSTRACT

The present invention relates to a device in a machine for cutting or clearing of plant growth, e.g. grass, reeds, thickets etc., in that the growth is impacted by means of an impact device which is mounted on a shaft for rotation thereof, the impact device displaying a number of hose-shaped arms (6, 7).

The present invention relates to a device according to the preamble to appended Claim 1.

In many situations, steadily increasing demands are being placed on the clearing or cutting of substantially wild plant growth such as grass, reeds, thickets, scrub etc, for creating open spaces at various natural areas close to and away from built-up areas. However, such clearing is linked to large-scale labour input, both with and without machinery. Even though the available machinery facilitates the clearing work, this work is still linked to relatively great risks of working injury or considerable wear on the equipment, in particular the impact device proper or the cutting device which, in most cases, consists of rotating knives and trimmer wires of different types. Knives are most common in lawnmowers of different types, while wires are commonest in trimmer clearing machines, which, for the greater part, consist of clearing saws which have been provided with a thread or wire head in the form of a thread magazine from which thread is paid out for the formation of two opposing thread ends extending out from the thread magazine head. However, the handling of such thread heads is quite complicated and relatively time-consuming. In addition, the consumption of thread is relatively considerable. There are many different types of threads or wires, but none has yet proved to give the desired results. There is obviously a major need in the art for a simple mechanism with an impact device or cutting device with a considerably better service life than the different types of wires or threads employed. Moreover, the impact device or the cutting device must, after possible wearing out, be simple to replace without the need of returning the machine to a workshop.

The task forming the basis of the present invention is to satisfy the above-outlined needs in the art.

This task is solved according to the present invention in that the device disclosed by way of introduction has been given the characterising features as set forth in appended Claim 1.

The present invention realises a device with an extremely simple design and construction and considerable service life compared with prior art devices. Possible replacement of the impact- or cutting device is extremely simple and can be carried out without any difficulty whatever at the worksite, without the need of access to a workshop.

One embodiment of the present invention will now be described in greater detail hereinbelow with reference to the accompanying Drawings.

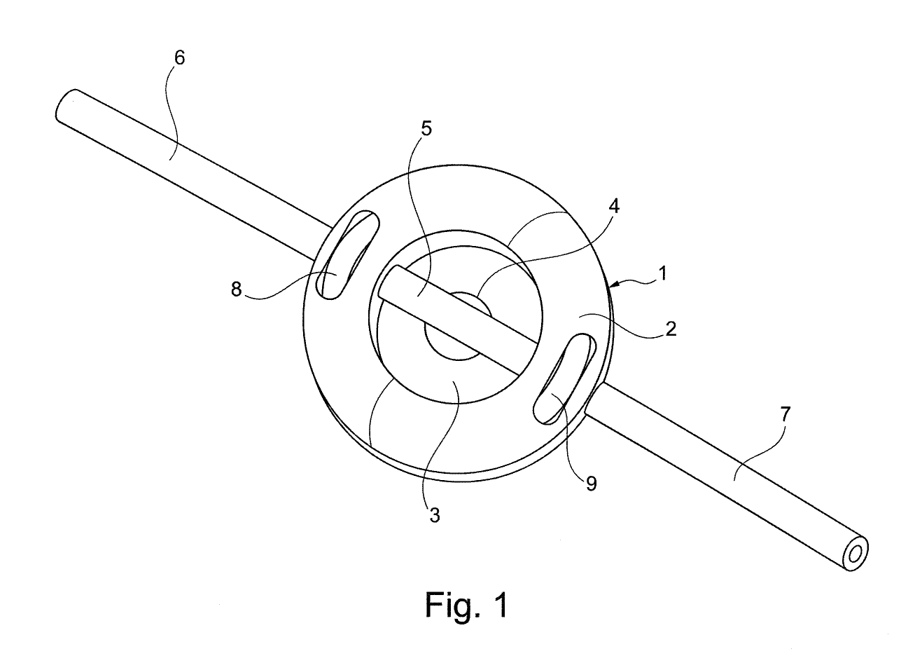

FIG. 1 is a photographic representation in one direction of one embodiment of a device according to the present invention.

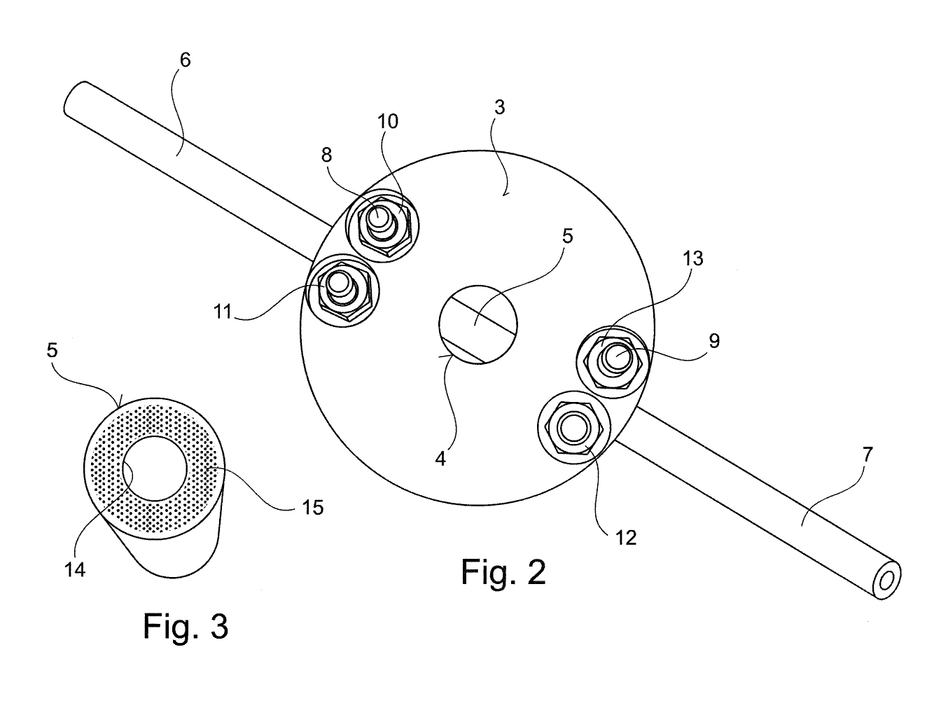

FIG. 2 is a photographic representation in the opposite direction of the embodiment according to FIG. 1.

FIG. 3 is a photographic cross section through a part of the embodiment according to FIGS. 1 and 2.

The embodiment of a device according to the present invention shown on the Drawings is in the form of a hub cap 1 with an annular wall 2 and a bottom 3. The annulus need not be circular. The bottom 3 has a centre hole 4. The centre hole 4 is intended for mounting of the hub cap 1 on the end of a shaft of, for example, a bush saw of suitable type available on the market.

The wall 2 of the hub cap 1 displays two mutually registering holes. A hose 5 extends through the holes in the wall 2 of the hub cap 1, so that, on either side of the hub cap 1, there is formed an arm 6 and 7. The arms 6 and 7 should advantageously be substantially equal in length.

The wall 2 of the hub cap 1 is suitably so high that there is space between the hose 5 and that shaft end which extends through the centre hole 4 and the lock nut mounted on the end of the shaft.

The hose 5 is fixed in the hub cap 1 with the aid of wire locks 8 and 9 which extend through axial holes in the wall 2 of the hub cap 1 on either side of the hose 5. Each wire lock 8 and 9 is anchored in the hub cap 1 by means of two nuts 10, 11 and 12, 13, respectively, on the underside of the bottom 3 of the hub cap 1.

The bridge between the axial holes in the wall 2 of the hub cap 1 is recessed so that the wire locks 8 and 9 come into contact with the hose 5 for clamping thereof in the hub cap 1. For improving the locking action of the hose 5, the recessing of the bridge, the crown or the wall material between the axial holes for the wire locks 8 and 9 can be deeper than the lower edge of the radial holes in the wall 2 of the hub cap 1. That part of the wire locks 8 and 9 which comes into contact with the hose may be provided with a friction-promoting means e.g. knurling or the like.

On the underside of the bottom of the hub cap 1, the axial holes are advantageously diametrically enlarged so that the nuts 10, 11 and 12, 13 will be substantially countersunk therein and permit tightening and loosening by means of a box spanner. The nuts 10, 11 and 12, 13 are suitably of the self-locking type. The hub cap 1 is suitably manufactured from an appropriate aluminium alloy. The wall 2 of the hub cap 1 may suitably, between the axial holes of the wire locks 8 and 9, be provided with interior and/or exterior recesses and/or recesses for reducing the weight of the hub cap 1 and thereby the overall weight of the device.

The hose 5 is manufactured from rubber or other flexible, rubber-like material and, as is apparent from FIG. 3, the hose 5 has an inner circular through-going hole 14 and, in the wall of the hose 5, there is disposed a multi-layer wire reinforcement 15. The wires may consist of a suitable metal wire. It will be obvious to the skilled reader that the wire reinforcement 15 is enclosed in the hose material so that the rubber or the flexible rubber-like material is whole and intact on both the inside and the outside of the hose 5.

The wire reinforcement may be sock-like or of the same type as the shield in an antenna cable. The wire reinforcement may suitably by of the same type as that which occurs in prior art high pressure hoses and the like, e.g. hydraulic hoses.

Many modifications of the above-described embodiment of the device according to the present invention are naturally possible without departing from the scope of the inventive concept as defined in the appended Claims.

1. A device in a machine for cutting or clearing of plant growth, e.g. grass, reeds, thicket etc., in that the growth is impacted by means of an impact device which is mounted on a shaft for rotation thereof, characterised in that the impact device displays a number of hose-shaped arms (6, 7).

2. The device as claimed in claim 1, characterised in that the hose-shaped arms (6, 7) are provided with a wire reinforcement (15).

3. The device as claimed in claim 2, characterised in that the wire reinforcement (15) in the hose-shaped arms (6, 7) displays a large number of wires in one or more layers.

4. The device as claimed in any of the preceding Claims, characterised in that the hose-shaped arms (6, 7) are of circular cross section.

5. The device as claimed in any of the preceding Claims, characterised in that the hose-shaped arms (6, 7) are anchored in a hub (1) with a centre hole (4) for mounting on a shaft for rotation by means thereof.

6. The device as claimed in claim 5, characterised in that the hub (1) is cap-shaped, the centre hole (4) being located in the bottom (3) of the hub cap (1), and the hose-shaped arms (6, 7) being anchored in the wall (2) of the hub cap (1).

7. The device as claimed in claim 6, characterised in that the hose-shaped arms (6, 7) are formed from a reinforced hose (5) which extends through the wall (2) of the hub cap (1), for forming two mutually registering arms (6, 7) extending out from the hub (1).

8. The device as claimed in claim 7, characterised in that the hose (5) is anchored by means of at least one wire lock (8, 9) whose shanks extend through axial holes in the wall (2) of the hub cap (1) on either of the hose (5) and are anchored by means of nuts (10-13).
